(19) United States
(12) Patent Application Publication
(10) Pub. No.: US 2010/0151962 A1
(43) Pub. Date: Jun. 17, 2010

(54) TWO PIECE CLUB CONSTRUCTION APPARATUS AND METHOD

(76) Inventors: Joshua G. Breier, Carlsbad, CA (US); Charles E. Golden, Carlsbad, CA (US); Scott A. Rice, Carlsbad, CA (US)

Correspondence Address: HANIFY & KING PROFESSIONAL CORPORATION, 1055 Thomas Jefferson Street, NW, Suite 400, WASHINGTON, DC, 20007, US

(21) Appl. No.: 12/335,695

(22) Filed: Dec. 16, 2008

(51) Int. Cl. A63B 53/04; B23P 11/00

(52) U.S. Cl. 473/345; 473/349; 29/527.5; 29/525.01

(57) ABSTRACT

A method and apparatus for forming a golf club head is disclosed. The golf club head includes a first and second part, each of which may include more than one portion of the golf club head. The two parts are operatively connected using a single, continuous, non-planar weld line. Preferably, the weld line passes through a transition between the face and either the crown of the club or the sole of the club. Each portion of the club may include different percentages of the face and/or body, providing the advantage of minimizing manufacturing costs and time while controlling club head performance attributes to a higher level of precision.

### FIELD OF THE INVENTION

The present invention relates to golf club head design. More specifically, the present invention relates to a method and apparatus for constructing a two piece golf club head using a single weld line.

### BACKGROUND OF THE INVENTION

As every golfer realizes, the properties of a golf club can greatly impact the trajectory of a golf ball. On a basic level, this is evident from the various types of golf clubs, such as woods, drivers, irons, and putters, from which a golfer may choose. For instance, a driver is typically used to propel a golf ball as far as possible, while irons may be used for hitting the ball shorter distances. Knowing the properties of the different clubs, such as loft angle, center of gravity, and moment of inertia can help golfers determine which club to use in a particular situation.

In the constantly evolving field of golf club manufacturing, various methods have been contemplated for varying the properties of a golf club head. With the discovery of composite materials, manufacturers have been able to manipulate golf club heads to move the center of gravity towards the back of the club head, which generates a larger “sweet spot.” Incorporating composite materials into golf club heads has also allowed manufacturers to push the center of gravity lower toward the ground plane, which yields a high launch/low spin golf ball trajectory after impact. In addition, other properties of the golf club head have been manipulated by piecing together different components to construct a club head.

According to the prior art, golf club heads may be manufactured by using a “face pull” or “sole pull” method. In the “face pull” method, the body of the club head is manufactured around a mold that takes up the inner volume of the club head. Once the body is formed, the mold is pulled through the area where the face is eventually positioned. A face may then be manufactured that has varying properties, e.g., loft angle, lie angle, exterior curvature (bulge/roll), and variable thickness, and attached in the appropriate place. This allows the performance properties of the face to be varied while keeping the body constant, however, the precision to which face angles, curvatures, and thicknesses can be controlled is traditionally quite low due to the large manufacturing variances associated with this process. The face may be attached through a variety of methods, including laser weld, plasma weld, brazing, swaging, bonding, mechanical locking, and/or co-molding. Each of these methods may be manipulated in the manufacturing process to further influence the performance properties of the golf club head.

The “sole pull” method similarly forms the face, skirt, and crown of the club head around a mold that represents the inner volume of the club head. Once the face, skirt, and crown are formed, the mold is removed though the area where the sole is eventually positioned. A sole with varying properties may then be connected to the remainder of the club head. Welding has traditionally been the attachment method of choice for joining both face pieces and sole pieces of similar material to the golf club body. A disadvantage of both of these welded-piece face pull and sole pull methods of manufacture, however, is that the weld line used to connect the various pieces is in areas of the club that are most subject to cyclic external loading. The face plate, for example, experiences significant shear forces directed perpendicular to the face plane upon impact with a golf ball, and ground contact can initiate stresses within the sole plate. Weld lines, however, can be prone to brittle failure near the weld zone. Plasma and laser welding processes heat the joined materials to ultra-high temperatures, creating a heat affected zone in and around the weld line that is harder and more brittle than the original material. This heat affected zone is often inferior in shear strength relative to the surrounding material, and therefore it is susceptible to fatigue failure from repeated loading.

In even more complicated methods, some of today's club heads are manufactured from three or more components that are assembled to construct a golf club head. Each of the components, such as a face, skirt, sole, and crown, may be manufactured individually and then assembled to form a complete golf club head. One way that manufacturers put the various parts of a club head together is by welding. However, a downside to using various components to manipulate the golf club head properties is that welding three or more parts together is more time consuming, expensive, and requires greater technological expertise.

Along these lines, a continuing need exists for a method and apparatus that minimizes the time, expense, and technological expertise necessary to manufacture a golf club head while allowing the golf club head properties to be controlled to a higher level of precision than traditional construction processes.

### SUMMARY OF THE INVENTION

In order to solve the drawbacks of the prior art discussed above, one aspect of the present invention relates to a golf club head that includes a first part comprising between about 50% to about 90% of the face and less than about 50% of the body. Also included is a second part that includes the remainder of club head. Preferably, a single weld line operatively connects the first part and the second part so that the two parts together form a substantially complete club head.

In one embodiment, the single weld line preferably comprises a non-planar weld line. In order to minimize the chance of the structural integrity of the club head from being compromised during contact with an object, it is desirable for the single weld line to pass along the transition between the face and the head. For similar reasons, it is also desirable for the single weld line to pass along the transition between the face and the sole.

As discussed herein, the body may include a crown, a skirt, and a sole, and the single weld line passes along about 80% or more of the transition between the face and a crown. Alternately, the body may include the crown, skirt, and sole, and the first part may include less than about 40% of the skirt. In yet another embodiment, the body may include the crown, skirt, and sole, and the single weld line preferably passes through the skirt. It is desirable for the first part to comprise about 70% or more of the weight of the club head.

In another aspect, the present invention includes a golf club head that includes a first part that comprises less than about 50% of the face and greater than about 30% of the body. The second part may include the remainder of the club head. The two parts may be connected by a single non-planar weld line operatively connecting the first part and the second part, where the single non-planar weld line is the only weld line.

In this aspect, the single non-planar weld line may pass along the transition between the face and the sole, or it may pass along the transition between the face and the crown. The body preferably includes the crown, skirt, and sole, and the single non-planar weld line passes along about 50% or less of the transition between the face and the sole. Alternately, the body includes the crown, skirt, and sole, and the single non-planar weld line passes along about 50% or less of the transition between the face and the crown.

In another embodiment, the body comprises the crown, skirt, and sole, and the single non-planar weld line passes along the crown, skirt, and sole such that it substantially bisects the crown, skirt, and sole. Preferably the first part comprises less than about 40% of the weight of the club head.

According to an exemplary method, the present invention includes a method for manufacturing a golf club head. The method includes the steps of forming a first part of the club head, where the first part comprises greater than about 80% of the face and less than about 50% of the body. Then, a second part of the club head is formed, with the second part comprising the remainder of the club head. Finally, the first and second parts of the club head may be welded together using a continuous non-planar weld line.

In one aspect, the first and second parts are welded together along a transition between a face and a sole of the club head. Additionally, the first and second parts are welded together along about 55% or less of a transition between a face and a crown of the club head. The first and second parts may be cast, or any other method known to those skilled in the art may be used. Any method of welding the two parts together may be used including, but not limited to, laser welding, plasma welding, or precision milling.

One advantage of the present invention is that tighter tolerances may be achieved. In one aspect, the present invention preferably achieves a tolerance of between plus or minus about 0.10 degrees and about 1.0 degrees. In other embodiments, the present invention achieves a tolerance of less than plus or minus about 0.30 degrees.

### BRIEF DESCRIPTION OF THE DRAWINGS

Further features and advantages of the invention can be ascertained from the following detailed description that is provided in connection with the drawings described below:

FIG. 1 is a diagram showing an exemplary embodiment of a golf club head according to one aspect of the present invention;

FIG. 2 is a diagram showing another exemplary embodiment of a golf club head according to one aspect of the present invention;

FIG. 3 is a diagram showing yet another exemplary embodiment of a golf club head according to one aspect of the present invention;

FIG. 4 is a diagram showing an exemplary embodiment of a golf club head according to another aspect of the present invention; and

FIG. 5 is a diagram showing an exemplary embodiment of a golf club head according to still another aspect of the present invention.

### DETAILED DESCRIPTION OF THE PREFERRED EMBODIMENTS

The present invention generally relates to a golf club head that is manufactured using a single weld line. Along these lines, it is desirable for the single weld line to operatively connect two pieces that together form a substantially complete golf club head. Each of the two pieces may form two or more portions of the club head, thereby reducing the need for additional weld lines. Preferably, the two pieces are connected by a single weld line that is continuous and non-planar. As used herein, a “part” refers to the two elements that together form the substantially complete golf club head, whereas a “portion” refers to different parts of the golf club head, e.g., the crown, sole, skirt. A “part” may include two or more “portions” of the golf club head.

According to one aspect, the present invention may be used with any type of club known to those skilled in the art, including irons, wedges, woods, putters, drivers, and the like. The golf club head may include a face, skirt, crown, sole, and hosel. The face preferably includes score lines, or grooves, that aid in imparting spin to a golf ball during impact. In addition, other elements may be operatively combined with the club head, or they may be separate bodies, such as inserts, coupled thereto. Although the club head is described herein with respect to a driver, it will be understood that the present invention is applicable to any type of club known to those skilled in the art.

In embodiments where the club head comprises a driver, various properties of the club head may be changed as desired. For instance, the club head weight, size, and moment of inertia (MOI) may optionally be varied. According to one aspect, for example, the club head preferably has a volume between about 100 and about 600 cubic centimeters (cc). More preferably, the club head has a volume between about 200 and about 500 cc. Most preferably, the club head has a volume between about 300 and about 475 cc.

The club head may also be manipulated by varying the MOI. A first way to describe the MOI is by the MOI from heel to toe. Preferably, the MOI from heel to toe is about 3000 g-cm² or greater. More preferably, the MOI from heel to toe is about 4000 g-cm² or greater. Most preferably, the MOI from heel to toe is about 5000 g-cm² or greater. In another aspect, the MOI from heel to toe is preferably between about 1000 g-cm² and about 8000 g-cm². More preferably, the MOI from heel to toe is between about 3000 g-cm² and about 8000 g-cm². Most preferably, the MOI from heel to toe is between about 5000 g-cm² and about 8000 g-cm².

A second way to describe the MOI is by the MOI from top to bottom. Preferably, the MOI from top to bottom is about 2000 g-cm² or greater. More preferably, the MOI from top to bottom is about 3000 g-cm or greater. Most preferably, the MOI from top to bottom is about 4000 g-cm² or greater. In another embodiment, the MOI from top to bottom is preferably between about 500 g-cm² and about 7000 g-cm². More preferably, the MOI from top to bottom is between about 2000 g-cm² and about 7000 g-cm². Most preferably, the MOI from top to bottom is between about 3000 g-cm² and about 7000 g-cm².

The total weight of the club head may also be varied, and may depend on the type of club used. For instance, in one embodiment the total weight of the club head is preferably between about 190 grams (g) and about 210 g. More preferably, the total weight of the club head is between about 195 and about 205 g. Most preferably, the total weight of the club head is between about 197 g and about 200 g. Alternately, the total weight of the club head is preferably about 190 g or greater. More preferably, the total weight of the club head is about 200 g or greater. Most preferably, the total weight of the club head is about 220 g or greater.

In another aspect, the total weight of the club head is preferably between about 200 g and about 220 g. More preferably, the total weight of the club head is between about 205 g and about 215 g. Most preferably, the total weight of the club head is between about 207 g and about 210 g. Those skilled in the art will understand that the desired weight of the club head may be selected based on the type of club used, e.g., a driver, fairway, iron, and the like.

It is desirable for the club to include any type of material known to those skilled in the art. Examples of materials that may be used include, but are not limited to, metals, composites, rubber, glass, plastic, and alloys. In particular, some parts of the club head may be formed of a metallic material such as stainless steel, aluminum, or titanium. These materials may be chosen such that they can withstand the stresses and strains incurred during a golf swing, including those generated through striking a golf ball or the ground. Preferably, the club head is engineered to create a primary load bearing structure that can repeatedly withstand such forces.

Other portions of the club head, such as the skirt, experience a reduced level of stress and strain and may be replaced with a lighter, weight-efficient secondary material. Lighter weight materials, such as low density metal alloys, plastic, composite, and the like, which have a lower density than or equivalent density to the previously mentioned metallic materials, can be used in these areas, allowing the club head designer to redistribute the “saved” weight or mass to other, more beneficial locations of the club head. Other properties of these portions of the club head may also be manipulated, e.g., by making them thinner to enhance the weight savings.

For instance, the face and sole of the club head may be formed from a metal, such as 8-11 castable Titanium (Ti) or 3-2 Ti. To achieve weight savings, the crown may be manufactured from a composite. Alternately, the face does not have to be completely metal. Instead, the face may include a matrix of composites and metals.

As mentioned above, it is desirable for the present invention to be used with any type of club known to those skilled in the art. The club heads used may have a variety of different characteristics. One example of a characteristic that may be varied is the hosel of the club head. Many different types of hosels are known to those skilled in the art, including single hosels, two piece hosels, multiple piece hosels, hosels with insulating material, and the like, any of which may be used. Additionally, the present invention may be used in combination with any type of club shaft, having any desired properties known to those skilled in the art.

According to one aspect, the club head of the present invention comprises two parts that are operatively connected. Each of the two parts may include more than one portion of the club head. For instance, a first part may include the face and the sole, whereas the second part may include the crown and the skirt. Alternately, a first part may include the crown, the face, and the skirt, while the second part may include only the sole.

The first and second parts of the club head may be manufactured using any method and/or apparatus known to those skilled in the art. For instance, the two parts may be cast using a mold. Because the two parts are essentially open bodies, they are substantially easier to cast than prior art methods such as the “face pull” and “sole pull” methods described above. In other embodiments, the first and second parts may be stamped, forged, machined, or even precision-milled, three processes that could provide tighter manufacturing tolerances on head angles, curvatures and wall thicknesses than traditional casting methods. Skilled artisans will understand that different manufacturing methods may be used to form each part.

The present invention is described herein with respect to first and second parts, that together form a substantially complete club head. As used herein, a complete club head refers to a club head that includes substantially all of the portions necessary to form a club head, e.g., a face, skirt, sole, and crown. In some embodiments, a complete club head may also include a hosel that is formed in at least one of the two parts. It will be understood that other elements, e.g., weights, indicia, aesthetic effects, and the like may be added to the “complete club head” as desired by those skilled in the art. In any event, the first and second parts form the complete club head in terms of being a functional unit that is substantially operable to be used to strike a golf ball.

Further processing may be performed once the two parts of the club head are operatively connected. The processing may include smoothing, adding score lines, adding weight or insulating members, or removing portions of the club head.

As described herein, skilled artisans will recognize that a club head includes four major components: (i) a face, i.e., the striking surface of the club; (ii) a crown, i.e., the top portion of the club; (iii) a skirt, i.e., the portion of the club head between the crown and the sole of the club that extends around the perimeter of the club (excluding the face); and (iv) a sole, i.e., the bottom portion of the club that comes into contact with the ground most often. As described in detail below, the crown, skirt, and sole, are collectively described herein as the “body” of the club head. The present invention is now described with reference to these portions of the club head, each of which are well known to those skilled in the art.

One advantage of using two parts to form a club head is that a single weld line may be used to connect them together. Using only one weld line allows the expense of manufacturing the club head to be minimized while increasing the efficiency of the process. As described herein, the weld line refers to the welding area created where the mating surfaces of the two pieces are welded together. Moreover, a single weld line refers to the fact that the weld line is substantially continuous and uninterrupted.

In one embodiment, the weld line described herein is the only weld line present in the club head. In other words, because the first and second parts form a substantially complete club head, only one continuous weld line is needed to operatively connect them. It may be desirable, in certain circumstances, to use additional weld lines to connect other elements, e.g., internal or external weights, a hosel, insulating material, or hosel inserts, to the club head. However, those skilled in the art will understand that only one continuous weld line is necessary to form the complete club head.

In one embodiment, it is desirable for the weld line to be non-planar. In other words, the weld line is not a straight line that wraps around the club head. Thus, the weld line does not wrap completely around the face to join it to the body of the club, as is the case with the “face pull” method described above. According to one aspect, the weld line does not encroach upon the hitting area of the face, which reduces the likelihood of fatigue failure in the weld zone due to cyclic impact loading of the face. In other words, it is desirable for the weld line to be positioned such that it is substantially close to the seam or transition between two different portions, e.g., the face and the sole.

Skilled artisans may choose to include different portions of the club head in each of the first or second parts in order to vary club head characteristics, as described below, or to vary the location of the weld line. For instance, having either the first or second part comprise the entire face may move the weld line away from the striking surface, which may prevent it from affecting the trajectory of a golf ball. Or, the portions of the club included in the first and second parts may be varied such that the stress imposed on the weld line during impact with a golf ball is minimized. It may also be desirable to modify the portions of the club included in the first and second parts to allow various characteristics of the club head, e.g., lie, loft, face angles, and wall thicknesses to be optimized and controlled to a much higher degree of precision than that afforded by traditional “face pull” or “sole pull” methods.

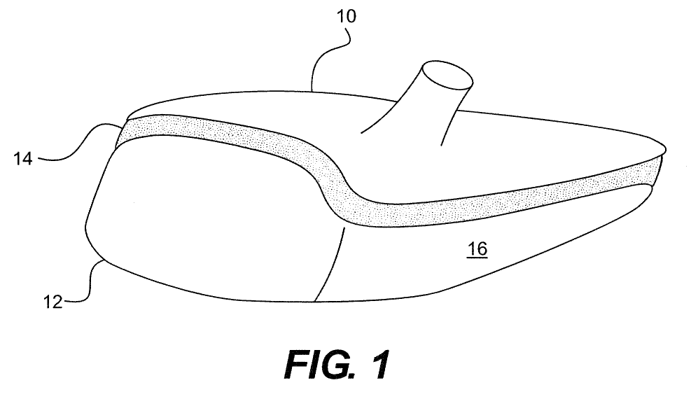

Along these lines, various exemplary embodiments of the first and second parts and weld lines are described below with respect to FIGS. 1-5. Those skilled in the art will recognize that the weld lines shown in the various figures have been enlarged for illustrative purposes only. It will be understood that it is desirable to minimize the appearance of weld lines during the manufacturing process in order to prevent separation of the various elements and to prevent the weld lines from affecting the trajectory of an object struck by the golf club head. Moreover, the placement of the weld lines shown in the diagrams is an approximation used for illustrative purposes, and is not intended to limit the scope of the present invention.

FIGS. 1-5 show embodiments of a club head according to different aspects of the present invention. In particular, FIG. 1 is a diagram showing a first embodiment of the present invention where the first upper part 10 includes the crown and a portion of the skirt of the club head. The second lower part 12 includes the sole and the remaining portion of the skirt. In this embodiment, the weld line 14 connects the first 10 and second 12 parts to form a substantially complete club head.

As shown in FIG. 1, the weld line 14 is formed around the skirt of the club head near the toe (not shown), the heel, and the back of the club head. Because the second part 12 includes substantially all of the face of the club head, the weld line in the front of the club is formed at the top of the face, and connects the face to the crown of the club head. Those skilled in the art will note that the weld line 14 is non-planar.

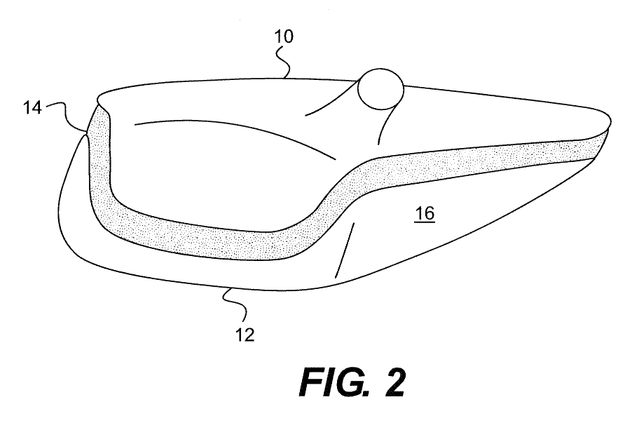

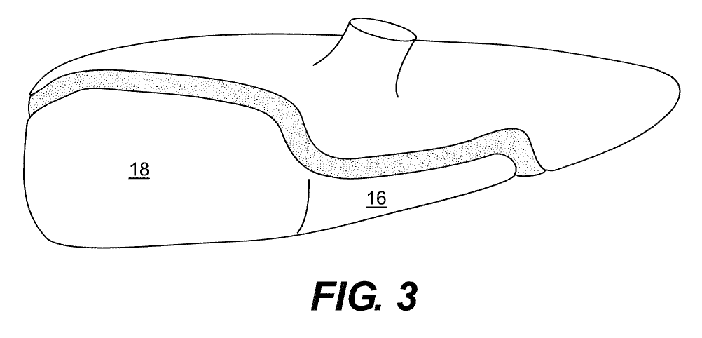

In the embodiment shown in FIG. 2, the first part 10 comprises a portion of the face and portion of the body. In this embodiment, the weld line 14 is formed towards the bottom part of the face and connects the first 10 and second 12 parts near the skirt 16. The FIG. 3 embodiment is similar to the FIG. 1 embodiment in that the weld line 14 is at the top of the face 18. However, instead of the weld line passing along the top part of the skirt 16 in the back of the club, the weld line 14 of the FIG. 3 embodiment begins at the skirt 16 but then drops to the bottom part of the skirt 16, i.e., where the skirt 16 and sole meet.

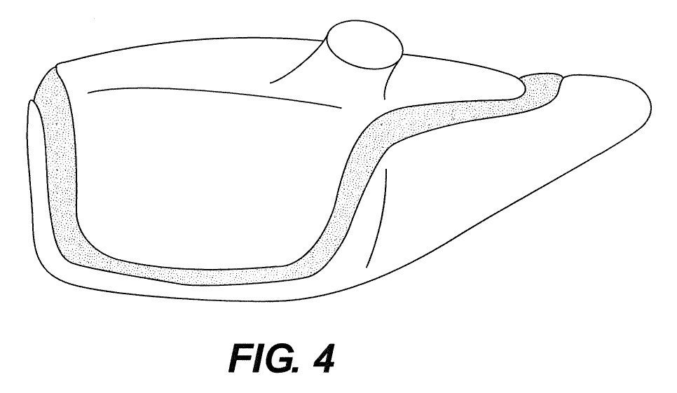

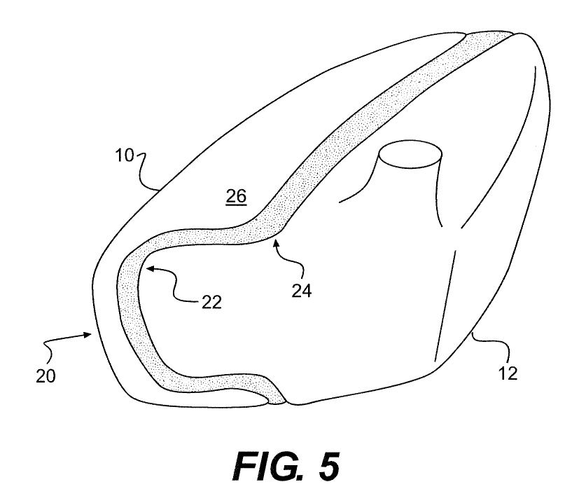

In other aspects, the position of the weld line may be positioned in different areas. For example, the FIG. 4 embodiment is similar to the FIG. 2 embodiment in that the weld line 14 passes along the bottom of the face 18, where the sole and the face come together. The weld line 14 shown in FIG. 4, however, occupies a top portion of the crown, instead of being positioned at the skirt 16 of the club. In other aspects of the present invention, the weld line may be varied in other manners as desired by those skilled in the art. For example, in the embodiment shown in FIG. 5 the weld line 14 begins midway along the face 18 near the sole of the club. It then passes along the face 18 near the toe 20 of the club, and at the top 22 of the face 18 it begins to pass along the top of the face 18 near the midpoint 24 of the crown 26. The weld line 14 preferably connects the first 10 and second 12 parts along the midpoint of the crown, passes around the midpoint of the skirt (not shown), and finally wraps around the midpoint of the sole (substantially opposite the weld line shown passing through the crown 26).

As is evident from the FIG. 1-5 embodiments, the position of the weld line 14 may be varied considerably. In one aspect, the weld line of the present invention may be positioned along a portion of the face 18 of the club head. Specifically, the weld line 14 may pass along the transition of the face, i.e., the part of the face that transitions into the crown or the sole, as shown in FIGS. 1-4. For instance, in the FIG. 1 and 3 embodiments, the weld line 14 passes along the top of the face 18. Alternately, the weld line 14 may pass along the bottom of the face 18, as shown in FIGS. 2 and 4.

In one aspect, the weld line passes preferably through about 50% or more of the transition between the face and the crown and/or sole. More preferably, the weld line passes through about 70% or more of the transition between the face and the crown and/or sole. Most preferably, the weld line passes through about 95% or more of the transition between the face and the crown and/or sole.

According to another embodiment, the weld line preferably passes through between about 70% and about 100% of the transition between the face and the crown and/or sole. More preferably, the weld line passes through between about 80% and about 100% of the transition between the face and the crown and/or sole. Most preferably, the weld line passes through between about 90% and about 100% of the transition between the face and the crown and/or sole.

Manufacturing the club head with a small weld line is desirable for both aesthetic as well as functional reasons. That is, the size of the weld line is preferably minimized when the two parts are assembled properly. A large weld line may indicate that the two pieces are not mated together adequately to prevent separation. Along these lines, it is desirable to minimize the size of the weld line with respect to the total size of the club head, in terms of surface area of the club head.

A useful way to describe the size of the weld line with respect to the surface area of the club head is by the ratio of the total surface area of the club head to the total surface area of the weld line. Preferably, the ratio of the surface area of the club head to the surface area of the weld line is maximized, which means that the size of the weld line is minimized. In one embodiment, the ratio of the surface area of the club head to the surface area of the weld line is about 1000:1 or greater. More preferably, the ratio of the surface area of the club head to the surface area of the weld line is about 10,000:1 or greater. Most preferably, the ratio of the surface area of the club head to the surface area of the weld line is about 100,000:1 or greater.

The position of the weld line with respect to the face is important because this is the area that a golf ball will come into contact with most often. Thus, two factors arise: (i) the weld line should be strong enough to withstand repeated impacts; and (ii) the weld line should not affect the trajectory of the ball. Positioning the weld line either above or below the face, e.g. along the transition of the face, minimizes the chances of the weld line affecting the trajectory of a ball. In addition, using the welding methods described in more detail below prevents the structural integrity of the weld line from being compromised.

A different approach to the weld line is shown in the FIG. 5 embodiment. In this embodiment, the weld line passes along both the top and the bottom of the face 18. However, as shown in the FIG. 5 embodiment, the weld line only passes along about half of the top and bottom of the face. Additionally, the weld line above and below the face is joined by forming the weld line around the transition between the face and the toe 20 of the skirt. Thus, even in this embodiment, positioning the weld line above and below the face, and near the transition between the face and the toe 20, minimizes the chances of the weld line affecting the trajectory of the ball.

In the FIG. 5 embodiment, the weld line passes through about 55% or less of the transition between the face and the crown and/or sole. More preferably, the weld line passes through about 45% or less of the transition between the face and the head and/or sole. Most preferably, the weld line passes through about 40% or less of the transition between the face and the crown and/or sole. Alternately, the weld line may pass through between about 25% and about 60% of the transition between the face and the crown and/or sole. More preferably, the weld line passes through between about 25% and about 50% of the transition between the face and the crown and/or sole. Most preferably, the weld line passes through between about 25% and about 40% of the transition between the face and the crown and/or sole.

The remainder of the weld line along the body of the club head, i.e., away from the face, may be varied for a variety of reasons. One reason to vary the position of the weld line along the body of the club head is to vary weight distribution of the club head. In particular, it may be desirable for the first part to comprise the crown and the skirt of the club, while the second part includes the reminder of the club head.

For example, in the FIG. 5 embodiment, the weld line preferably bisects the crown, skirt, and sole. In other words, the weld line passes through the middle of each of these portions of the club head. If the first part is manufactured out of a first lighter material and the second part of the club is manufactured out of a second heavier material, the weight may be distributed such that the center of gravity is low and biased toward the heel, a configuration which typically yields a more desirable right-to-left ball flight (a “draw” for a right-handed player), as described in more detail below. In any event, the weld line may pass through the body based on the portions of the club head included in the first and second parts.

In other embodiments, the weld line may pass though portions of the club head that experience the least stress during impact with an object. For example, if it is determined that the skirt of the club head experiences a smaller amount of stress during impact than the rest of the club head, it may be desirable to have the weld line pass through the skirt. Because the weld line is likely to be an area of relative weakness of the club head, positioning the weld line along a lower stress area will minimize the chances of the structural integrity of the club being compromised.

One way to describe the club head of the present invention is with respect to the face and the body. In one embodiment, the first part preferably comprises between about 30% and about 90% of the face, and less than about 70% of the body. More preferably, the first part comprises between about 40% and about 90% of the face and less than about 60% of the body. Most preferably, the first part comprises between about 50% and about 90% of the face and less than about 50% of the body. In this embodiment, the second part includes the remainder of the club head.

In another embodiment the first part preferably comprises about 40% or more of the face. More preferably, the first part comprises about 60% or more of the face. Most preferably, the first part comprises about 85% or more of the face. In this embodiment, the first part preferably includes between about 10% and about 60% of the body. More preferably, the first part includes between about 20% and about 40% of the body. Most preferably, the first part includes between about 20% and about 30% of the body. As will be recognized by those skilled in the art, the second part comprises the remainder of the club head.

Another way to describe the club head of the present invention is with regard to each of the major components of the body, i.e., the crown, skirt, and sole. For instance, in one aspect the first part preferably comprises between about 25% and about 100% of the crown. More preferably, the first part comprises between about 40% and about 90% of the crown. Most preferably, the first part comprises between about 60% and about 85% of the crown. In another embodiment, the first part preferably comprises about 50% or more of the crown. More preferably, the first part comprises about 65% or more of the crown. Most preferably, the first part comprises about 85% or more of the crown. Alternately, the first part may include about 95% or less of the crown. More preferably, the first part may include about 80% or less of the crown. Most preferably, the first part may include about 60% or less of the crown.

In another aspect, the first part preferably comprises between about 10% and about 40% of the skirt. More preferably, the first part comprises between about 10% and about 25% of the skirt. Most preferably, the first part comprises between about 10% and about 15% of the skirt. In another aspect, the first part preferably includes less than about 60% of the skirt. More preferably, the first part includes less than about 25% of the skirt. Most preferably, the first part includes less than about 10% of the skirt. In yet another aspect, the first part preferably includes greater than about 5% of the skirt. More preferably, the first part includes greater than about 20% of the skirt. Most preferably, the first part includes greater than about 35% of the skirt.

According to one embodiment, the first part preferably includes between about 25% and about 90% of the sole. More preferably, the first part includes between about 35% and about 80% of the sole. Most preferably, the first part includes between about 45% and about 60% of the sole. In another embodiment, the first part preferably includes less than about 40% of the sole. More preferably, the first part includes less than about 25% of the sole. Most preferably, the first part includes less than about 15% of the sole. The first part preferably includes greater than about 10% of the sole in yet another embodiment. More preferably, the first part includes greater than about 15% of the sole. Most preferably, the first part includes greater than about 20% of the sole.

Those skilled in the art will understand that the present invention has been described herein with respect to the first part of the club head. Except where specifically stated, the second part will be understood to include the remainder of the club head. In addition, the ranges described herein for the various embodiments may be combined as desired. For instance, the first part may include between about 30% and about 90% of the face while also including between about 20% and about 40% of the body, even though range with respect to the face is described in relation to one embodiment while the range with respect to the body is described in relation to another embodiment.

Another way to describe the two parts of the club head is by the ratio of the first part to the second part. In other words, the first part may comprise a predetermined percentage of the total club head, while the second part may comprise the remainder. As such, the size of the first part with respect to the size of the second part may be described in terms of the ratio of the first part to the second part.

In one embodiment, for example, the ratio of the first part to the second part is preferably about 5:1 or less. More preferably, the ratio of the first part to the second part is about 3:1 or less. Most preferably, the ratio of the first part to the second part is about 1.5:1 or less.

The present invention includes the ability to modify the characteristics of the club head, including loft, lie, face angle and wall thickness while reducing the typical manufacturing tolerances associated with these parameters. In one embodiment, this may be accomplished by varying the characteristics of each of the first and second parts. One advantage of manufacturing a first and second part with varying characteristics is that a first and second part may be matched and welded together with minimal time and expense. In other words, the first and second parts may be interchangeable so that club heads with varying characteristics may be generated.

For example, in one aspect the first part may be generated with various roll, bulge, loft, lie, and face angles and/or offsets that are cast, forged, stamped, or milled to exact tolerances. In this embodiment, the first part does not include any portion of the sole. The second part, which includes the entirety of the sole, may be manufactured such that it can be combined with the first part. Alternately, it may be desirable to manufacture the second part with varying sole geometries. Varying sole geometries may be advantageous to manipulate the center of gravity, moment of inertia, or for aesthetic reasons.

One advantage of the present invention is the ability to customize various aspects of the parts of the club head, as described above. The customized aspects allow the present invention to achieve greater precision. For instance, greater precision may be achieved during the casting, forging, stamping, or precision milling process. In particular, tighter tolerances may be achieved using this technique to get desired face angles, lie angles, loft angles, and/or bulge or roll.

One example of the greater precision that may be achieved using the present invention is in an embodiment where the face is operatively connected to the hosel. The present invention achieves tighter tolerances which in turn get the desires increased precision for the face angle, loft angle, lie angle, bulge, and roll. Additionally, manufacturing methods, e.g., casting, normally have issues with the porosity of the manufactured materials. One aspect of the present invention can use numerous injection sites to reduce porosity to achieve a better result.

Typical prior art manufacturing tolerances are plus or minus 2 degrees. Using the methods and apparatus disclosed by the present invention, even tighter tolerances may be achieved. For instance, the present invention preferably achieves tolerances of less than plus or minus about 1.5 degrees. More preferably, the present invention achieves tolerances of less than plus or minus about 0.60 degrees. Most preferably, the present invention achieves tolerances of less than plus or minus about 0.30 degrees.

In another aspect, the present invention preferably achieves tolerances of between plus or minus about 0.10 degrees and about 1.0 degrees. More preferably, the present invention achieves tolerances of between plus or minus about 0.15 degrees and about 0.50 degrees. Most preferably, the present invention achieves tolerances of between plus or minus about 0.20 degrees and about 0.30 degrees.

Although specific ranges are disclosed herein, it is intended that the present invention is operable to achieve additional ranges within those disclosed. For instance, the low end of disclosed range may be increased while the high end may remain the same, or the low end may remain the same while the high end is decreased. Thus, although the achievable precision is described above as most preferably being between plus or minus about 0.20 degrees and about 0.30 degrees, it will be understood that a tolerance of between about 0.21 degrees and about 0.30 degrees, or between about 0.20 degrees and about 0.28 degrees is also contemplated by the disclosure herein of the broader range.

Each of the first and second parts shown in the FIGS. 1-5 embodiments may have varying properties. For instance, it is often desirable to manufacture a golf club so that the center of gravity is as far away from the face as possible. To do so, a golf club head may be manufactured so that the weight is distributed unevenly, with more weight located towards the back of the club head. According to one aspect of the present invention, each part of the club head may be manufactured so that the weight is distributed towards the back of the golf club. This may be accomplished in a variety of manners, including increasing the thickness of the material towards the back of the club head, and/or increasing the density of the material used to manufacture the back portions of the club head. Of course, it will be understood that the materials, density, and/or thickness of the materials used should be sufficient to maintain the structural integrity of the golf club during repeated impact with an object.

The foregoing description of the two piece construction of a golf club head makes it clear that the amount of time necessary to manufacture a golf club head can be reduced, along with cost, by using first and second parts that are interchangeable. In order to facilitate interchangeability, each part of the club head may be manufactured with corresponding interfaces that assist with connecting the two parts. In one embodiment, for example, the mating surface of the first part includes one or more protrusions, and the mating surface of the second part includes one or more corresponding recesses. The protrusions and recesses correspond such that connection of the two parts is facilitated.

Other methods known to those skilled in the art may also be used. In one aspect, an alternate method of facilitating interchangeability may be to use a “lock and key” system. In such an embodiment, one part may include one or more protrusions that have an interference fit with one or more recesses in the mating surface of the other part. This may be accomplished by forming the protrusions slightly larger than the opening of the recess, such that a force must be applied to allow the protrusion to enter the recess. The “lock and key” system refers to the fact that the interference fit preferably prevents the two parts from being separated, once they have been connected, unless a threshold mechanical force is applied to separate them. Alternately, the interference fit may prevent the two parts from being separated without applying a twisting force to one or both of the parts.

Though the mating interfaces of the two parts may be manufactured to facilitate interchangeability and to allow them to be connected, a stronger bond between the two is necessary in order to provide the structural integrity necessary to allow repeated impact with an object, e.g., a golf ball. To accomplish this goal, any method or apparatus known to those skilled in the art may be used. In one embodiment, for instance, the first and second parts may be joined using a technique referred to as laser beam welding (“LBW”), which is well known to those skilled in the art. LBW is a welding technique that is used to join pieces of metal through the use of a laser. The laser beam typically provides a concentrated heat source that allows for narrow, deep welds, with the added benefit of high welding rates.

In this embodiment, a continuous or pulsed laser beam may be used, depending on the properties of the material used to operatively connect the first and second parts. LBW may be used to weld a variety of materials including, but not limited to, carbon steels, stainless steel, aluminum, and titanium. An advantage of using LBW is that the laser can be transmitted through air, instead of requiring a vacuum. In addition, LBW can be easily automated with robotic machinery, which decreases manufacturing time and expense.

Another example of a method that may be used to weld the first and second parts is called robotic plasma welding. In plasma welding, a gas is heated to an extremely high pressure and ionized so that it becomes electrically conductive. A plasma arc welding process then uses this plasma to transfer an electric arc to the first and/or second parts. In this manner, the first and/or second parts melt because of the intense heat of the arc and fuse together. Plasma welding is also well know to those skilled in the art, and provides the advantage of producing high quality welds.

An embodiment of the present invention may implement finishing processes after the welding takes place. For instance, it is likely that there may be residue left over in the vicinity of the welding area after the first and second parts are welded together. As such, one example of a finishing process that may be used is a sanding or filing process that removes residue and smoothes the welding area. The advantage of using finishing processes such as this is that the club may be more aesthetically pleasing and the welding area, if near a striking surface, will be prevented from unexpectedly manipulating the trajectory of a golf ball.

According to one aspect of the present invention, the method of the present invention includes forming the first and second parts in the manner described above. As mentioned above, each of the two pieces may be formed having different properties, such as loft/lie angle, sole dimensions, and the like. In addition, because each of the two parts may be manufactured to have different portions of the club head, two parts that together form a substantially complete club head are preferably selected.

Then, each of the parts may then be operatively connected, for instance by welding them together, resulting in a substantially complete club head. Additional processing may be necessary to finish the club head. For instance, it may be desirable to add scoring lines to the face, and polish, paint, and/or smooth the two pieces. Additional parts may also be added to the club head, such as inserts, a hosel, vibration dampeners, weights, and the like. Finally, a shaft should be attached to the club head through the hosel in any manner known to those skilled in the art.

Although the present invention has been described with reference to particular embodiments, it will be understood to those skilled in the art that the invention is capable of a variety of alternative embodiments within the spirit of the appended claims. For instance, when portions of the club head are manufactured from composites or urethanes, weighted members may be included on the inside of the two pieces of the club head. The weighted members may fastened to one or both of the parts at any desirable point during the assembly of the club head. If ease of assembly is a primary concern, for example, the weighted members may be attached or fastened prior to operatively connecting the two parts. Those skilled in the art will recognize that the weighted members are preferably fastened to the inner surface of one or both parts, although in other aspects they may be fastened to their outer surfaces.

1. A golf club head, comprising:
a first part comprising between about 50% to about 90% of the face and less than about 50% of the body;
a second part comprising the remainder of club head;
a single weld line operatively connecting the first part and the second part, wherein the two parts comprise a substantially complete club head.

2. The golf club head of claim 1, wherein the single weld line comprises a non-planar weld line.

3. The golf club head of claim 1, wherein the single weld line passes along the transition between the face and the head.

4. The golf club head of claim 1, wherein the single weld line passes along the transition between the face and the sole.

5. The golf club head of claim 2, wherein the body comprises a crown, a skirt, and a sole, wherein the single weld line passes along about 80% or more of the transition between the face and a crown.

6. The golf club head of claim 1, wherein the body comprises a crown, a skirt, and a sole, wherein the first part includes less than about 40% of the skirt.

7. The golf club head of claim 1, wherein the body comprises a crown, a skirt, and a sole, wherein the single weld line passes through the skirt.

8. The golf club head of claim 1, wherein the first part comprises about 70% or more of the weight of the club head.

9. A golf club head, comprising:
a first part comprising less than about 50% of the face and greater than about 30% of the body;
a second part comprising the remainder of the club head; and
a single non-planar weld line operatively connecting the first part and the second part, wherein the single non-planar weld line is the only weld line.

10. The golf club head of claim 9, wherein the single non-planar weld line passes along the transition between the face and the sole.

11. The golf club head of claim 10, wherein the single non-planar weld line passes along the transition between the face and the crown.

12. The golf club head of claim 11, wherein the body comprises a crown, a skirt, and a sole, wherein the single non-planar weld line passes along about 50% or less of the transition between the face and the sole.

13. The golf club head of claim 11, wherein the body comprises a crown, a skirt, and a sole, wherein the single non-planar weld line passes along about 50% or less of the transition between the face and the crown.

14. The golf club head of claim 9, wherein the body comprises a crown, a skirt, and a sole, wherein the single non-planar weld line passes along the crown, skirt, and sole such that it substantially bisects the crown, skirt, and sole.

15. The golf club head of claim 9, wherein the first part comprises less than about 40% of the weight of the club head.

16. A method for manufacturing a golf club head, comprising the steps of:
a) forming a first part of the club head, the first part comprising greater than about 80% of the face and less than about 50% of the body;
b) forming a second part of the club head, the second part comprising the remainder of the club head; and
c) welding the first and second parts of the club head together using a continuous non-planar weld line.

17. The method of claim 16, wherein step c) comprises welding the first and second parts together along a transition between a face and a sole of the club head.

18. The method of claim 16, wherein step c) comprises welding the first and second parts together along about 55% or less of a transition between a face and a crown of the club head.

19. The method of claim 16, wherein step c) comprises one of:
laser welding;
plasma welding; or
precision milling.

20. The method of claim 16, wherein steps a) and b) comprise casting the first and second parts.

21. The method of claim 16, wherein steps a), b), and c) are performed with a tolerance of between plus or minus about 0.10 degrees and about 1.0 degrees.

22. The method of claim 16, wherein steps a), b), and c) are performed with a tolerance of less than plus or minus about 0.30 degrees.
